(19) United States
(12) Patent Application Publication
(10) Pub. No.: US 2022/0374081 A1
(43) Pub. Date: Nov. 24, 2022

(54) TACTILE PIXELS

(71) Applicant: UNIVERSITY OF BATH, Bath and North East Somerset (GB)

(72) Inventor: Ali MOHAMMADI, Bath (GB)

(21) Appl. No.: 17/755,205

(22) PCT Filed: Oct. 21, 2020
(86) PCT No.: PCT/GB2020/052636

§ 371 Date: Apr. 22, 2022

(30) Foreign Application Priority Data
Oct. 22, 2019 (GB) 1915283.4

(51) Int. Cl. G06F 3/01; G09B 21/00

(52) U.S. Cl. CPC G06F 3/016; G09B 21/004

(57) ABSTRACT

An apparatus comprising a solenoid having a first electrical input signal at a first frequency and a second electrical input signal at a second frequency; a first taxel, comprising a magnetic portion, located above an end of the solenoid, wherein the first taxel has a first mechanical resonance frequency such that applying the first electrical input signal to the solenoid causes the first taxel to vibrate; a second taxel, comprising a magnetic portion located above the end of the solenoid, wherein the second taxel has a second mechanical resonance frequency, different from the first mechanical resonance frequency, such that applying the second electrical input signal to the solenoid causes the second taxel to vibrate.

### BACKGROUND

Tactile pixels, otherwise known as taxels may be useful as human-machine interface devices for a number of applications, for example, to provide active interfaces to be used by blind or partially sighted people, for virtual reality applications (such as virtual training for surgeons), as sensory substitution devices, and in the automotive industry, for example to provide tactile feedback to assist a driver whilst driving. An array of tactile pixels can be used to convert pixelated graphical information generated e.g. by a mobile phone or computer to tactile stimulus.

Different approaches have been used to create tactile pixels based on electro-tactile, piezoelectric and electromagnetic transduction mechanisms. However many of these approaches suffer from lack of robustness (not being robust enough to withstand being regularly touched), low stimulation depth (making it hard for a user to detect whether a taxel is “on” or “off”), low spatial resolution, or low refresh rate. Using an electromagnetic transduction mechanism enables the taxel to be controlled with a high precision and a quick response rate—thereby providing a high refresh rate to an array composed of this type of taxel, and also provides a high stimulation depth. However, resolution can be limited by the size of the electromagnetic actuators used to control each taxel.

### SUMMARY

According to a first aspect of the disclosure there is provided an apparatus, which may be a taxel apparatus comprising: a solenoid having a first electrical input signal at a first frequency and a second electrical input signal at a second frequency; a first taxel, comprising a magnetic portion, located above an end of the solenoid, wherein the first taxel has a first mechanical resonance frequency such that applying the first electrical input signal to the solenoid causes the first taxel to vibrate; a second taxel, comprising a magnetic portion located above the end of the solenoid, wherein the second taxel has a second mechanical resonance frequency, different from the first mechanical resonance frequency, such that applying the second electrical input signal to the solenoid causes the second taxel to vibrate.

Using a solenoid to control the taxels enables a fast refresh rate and high precision for the taxels. The first aspect of the disclosure enables control of first and second taxels from a single solenoid. Therefore, the taxels can be located closer together which enables a higher resolution when used in an array of taxels. Since the first and second taxels have different mechanical resonance frequencies, they can be located close to each other and still controlled to vibrate selectively.

The first and second taxels may each comprise a cantilever beam attached to a frame at an attached end, wherein the magnetic portion is located at an unattached end of the cantilever beam.

This arrangement provides a strong level of vibration due to the mechanical resonance of the taxel (e.g. a sufficient level of vibration for detection by a user), whilst still being robust enough to be touched by a user.

The first taxel cantilever beam and the second taxel cantilever beam may each have different dimensions.

Controlling the mechanical resonance of the taxels by controlling the beam dimensions means that different resonance frequencies can be provided whilst keeping a mass of the end of the taxel the same. This means that identical tactile pads can be attached to the end of each taxel so that taxels having different mechanical frequencies feel similar to a user.

The first taxel cantilever beam and the second taxel cantilever beam may each have different widths.

Controlling the mechanical resonance of the taxels by controlling the beam widths manufactured e.g. by 3D printing, or using MEMS technology.

In some examples, the mechanical resonance of the taxels may be additionally or alternatively controlled by controlling the materials, or post-processed properties of the taxels.

The first and second taxels may both be attached to a single frame.

This arrangement means that the first and second taxels can be formed into a compact taxel array more easily.

The first and second taxels and the frame may be formed by 3D-printing (additive manufacturing). In some examples, all or part of the first and second taxels and the frame may be formed by another mass-production technique suitable for plastic or resinous materials such as using injection-moulding, vacuum-forming, blow-moulding or stamping technologies. This enables the taxel array to be produced in an efficient and low cost manner and produces taxels that are robust to being touched by a user. Other techniques, such as MEMS integrated circuit manufacturing processes may also be used.

The magnetic portion may comprise a soft ferromagnet, which may be easier to integrate in 3D printing or MEMS process compared with hard ferromagnets. This is due to soft ferromagnetic materials being easier to process. For example nickel can be processed at low temperatures which enables a powder to be integrated into 3D-printing. Soft ferromagnetic materials may also be more compatible with silicon MEMS processing techniques. Hard ferromagnetic materials are usually alloys, which tend to require harsher conditions such as very high temperatures to form the magnetic polarity.

In some examples the cantilever beam and the support frame may be formed from silicon.

These materials are robust yet flexible and therefore enable the taxel to vibrate with an amplitude that is detectable by a user while also increasing the useable lifetime of the taxel.

The solenoid may have a further electrical input signal at a third frequency, and the apparatus may further comprise a third taxel, comprising a magnetic portion, located at an end of the solenoid, wherein the third taxel has a third mechanical resonance frequency, different from the first and second frequencies, such that applying the third electrical input signal to the solenoid causes the third taxel to vibrate.

This enables more taxels to be located in a particular area, thereby increasing the resolution of an array including the apparatus, whilst still enabling each of the taxels to be selectively controllable.

The solenoid may have a further electrical input signal at a fourth frequency and the apparatus may further comprise a fourth taxel, comprising a magnetic portion located above the end of the solenoid, wherein the fourth taxel has a fourth mechanical resonance frequency, different from the first, second and third mechanical resonance frequencies, such that applying the fourth electrical input signal to the solenoid causes the fourth taxel to vibrate.

This enables more taxels to be located in a particular area, thereby increasing the resolution of an array of taxels, whilst also enabling the taxels to be selectively controllable. Additional taxels may also be provided, each having a different mechanical resonance, and a corresponding electrical input signal.

The apparatus may comprise a controller, wherein the controller is suitable to apply the first electrical input signal to the solenoid to vibrate the first taxel, and/or apply the second electrical input signal to the solenoid to vibrate the second taxel, and to apply the first and second frequencies to vibrate the first taxel and the second taxel, either simultaneously or individually.

This enables the taxels to be vibrated individually or at the same time.

The controller may be suitable to control the amplitude of the first and/or second electrical input signal in order to control the vibration amplitude of the first and/or second taxel.

This may enable the first and/or second taxels to be vibrated at different levels (i.e. stronger and weaker vibrations can be produced) which can be used to convey more information from the taxel to a user.

The controller may be suitable to control the first and second electrical input signals to each be applied at a relatively higher amplitude when the first and second electrical input signals are applied to the solenoid simultaneously, and is suitable to control the first and second electrical input signals to each be applied at a relatively lower amplitude when the first and second electrical input signals are applied to the solenoid individually.

As energy is split between multiple frequency components when vibrating both taxels simultaneously, increasing the amplitude of the third electrical signal means that the vibration amplitude of the taxels can be kept at a similar level, whether only one taxel is vibrating or if both taxels are vibrating simultaneously. However, if power is at a premium, for example in a battery powered mobile device, then the power can be shared across the individual taxels associated with the respective solenoid as required.

According to a second aspect of the disclosure there is provided a vibrotactile display comprising a plurality of solenoids arranged in an array, wherein each solenoid has a first electrical input signal at a first frequency and a second electrical input signal at a second frequency; a first taxel, comprising a magnetic portion, located above an end of each solenoid, wherein the first taxel has a first mechanical resonance frequency, such that applying the first electrical input signal to the solenoid causes the first taxel to vibrate; a second taxel, comprising a magnetic portion located above the end of each solenoid, wherein the second taxel has a second mechanical resonance frequency, different from the first mechanical resonance frequency, such that applying the second electrical input signal to the solenoid causes the second taxel to vibrate.

A vibrotactile display as defined by the second aspect provides a robust display with an increased resolution as with this arrangement only a single solenoid is required to support two (or more) taxels.

The vibrotactile display of the second aspect may comprise an apparatus according to the first aspect.

In some examples there is provided an apparatus comprising a vibrotactile display according to the second aspect, wherein the apparatus comprises one of a steering wheel, a seat bolster, a computer controller or games console controller and a surgical simulation instrument.

According to a third aspect of the disclosure there is provided a taxel array comprising a first taxel, comprising a magnetic portion, the first taxel having a first mechanical resonance frequency such that first taxel vibrates in response to the magnetic portion being energised by a first electromagnetic signal having a first frequency; and a second taxel, comprising a magnetic portion, the second taxel having a second mechanical resonance frequency such that second taxel vibrates in response to the magnetic portion being energised by a second electromagnetic signal having a second frequency.

The taxel array may further comprise a third taxel, comprising a magnetic portion, the third taxel having a third mechanical resonance frequency such that the third taxel vibrates in response to the magnetic portion being energised by a third electromagnetic signal having a third frequency.

The taxel array may further comprise a fourth taxel, comprising a magnetic portion, the fourth taxel having a fourth mechanical resonance frequency such that the fourth taxel vibrates in response to the magnetic portion being energised by a fourth electromagnetic signal having a fourth frequency.

The taxel array may comprise any of the features of the first aspect.

### BRIEF DESCRIPTION OF THE FIGURES

Non-limiting examples will now be described with reference to the accompanying drawings, in which

FIG. 1 shows a schematic representation of an example taxel apparatus.

FIG. 2 shows a top-down view of the example apparatus of FIG. 1.

FIG. 3 shows a schematic representation of another example taxel apparatus.

FIG. 4 shows a schematic representation of a vibrotactile display, comprising the taxel apparatus of FIG. 1.

### DETAILED DESCRIPTION

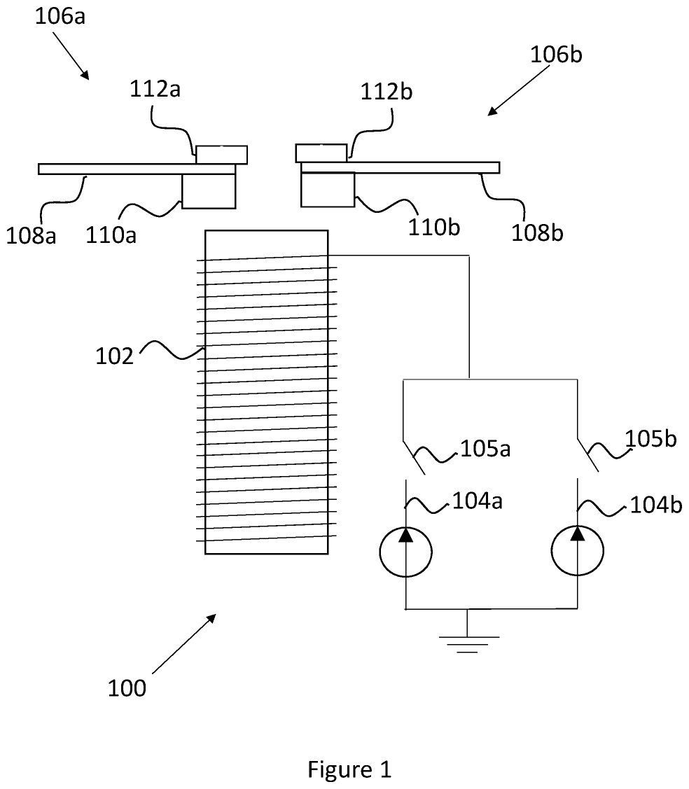

FIG. 1 shows a side view of an example taxel apparatus 100. The apparatus 100 comprises a solenoid 102 which may be, for example, 8 mm in diameter and in some examples may be built into a multilayer printed circuit board. Providing the solenoid as a built in component of a printed circuit board can reduce the overall thickness of the apparatus. The solenoid 102 has a first electrical input signal 104a at a first frequency and a second electrical input signal 104b at a second frequency. The first and second frequencies may each be generated, for example, by electronic oscillators, which may be integrated into a microcontroller. In the example shown in FIG. 1, the first and second electrical input signals 104a and 104b can be applied to the solenoid individually or simultaneously (or neither can be applied) at any given time, using switches 105a and 105b.

The apparatus 100 also includes a first taxel 106a which comprises a cantilevered support beam 108a, with a magnetic portion 110a located at an unattached end of the beam 108a. The taxel 106a is positioned relative to the solenoid 102 such that when the solenoid 102 is powered, a magnetic force is applied to the magnetic portion 110a, for example causing the magnetic portion 110a to be repelled away from the solenoid 102. The magnetic portion 110a is therefore located above an end of the solenoid, for example aligned with and spaced from one base of the solenoid 102. In some examples, the magnetic portion is located between 1 and 3 mm from the end of the solenoid. In some examples, the taxel is positioned on an adjustable metal platform such that the distance between the magnetic portion and the end of the solenoid is adjustable (for example, using a spring-bolt system). The metal platform may also act as a heat sink which can counteract any temperature increase from the solenoid. In some examples, the radial distance of the magnetic portion of the taxel from the axis of the solenoid is less than the radius of the solenoid coil.

In some examples, the magnetic portion 110a may be a separate part (e.g. a stainless steel part) that is attached to the beam 108a. In other examples the magnetic portion 110a may be part of the beam 108a, for example the beam 108a may be formed from a ferromagnetic material or may be impregnated with ferromagnetic powder. In some examples, the magnetic portion 110a may be a layer of ferromagnetic material (e.g. nickel) that is deposited onto the beam 108a.

In some examples, the magnetic portion 110a may be formed from a soft ferromagnetic material such as Nickel, Iron or NiFe. In other examples the magnetic portion 110a may be formed from a hard ferromagnetic material such as CoPt, FePt or NdFeB.

The cantilever support beam 108a may be attached to a frame (not shown in FIG. 1) at an attached end, which may be located relatively further from the axis of the solenoid 102 and may be free to vibrate at an opposite, unattached end, which may be located relatively closer to the axis of the solenoid 102. In the example shown in FIG. 1, the magnetic portion 110a is located at the unattached end of the beam 108a to increase the amplitude of the vibration produced at the taxel 106a.

In the example shown in FIG. 1, the first taxel 106a also comprises a tactile protrusion 112a or pad, located on an opposite side of the beam 108a from the solenoid 102, which is arranged to be touched during use of the apparatus 100 to transfer the vibrations of the first taxel 106a to a user's hand. The tactile protrusion 112a may be formed integrally with the beam 108a or may be attached to the beam 108a. The tactile protrusion 112a is located at the unattached end of the beam 108a to increase the amplitude of the vibration felt by a user from the taxel 106a.

The first taxel 106a has a first mechanical resonance frequency such that applying the first electrical input signal 104a to the solenoid 102 causes the first taxel 106a to vibrate at the first mechanical resonance frequency. In the example shown in FIG. 1, the mechanical resonance frequency of the first taxel 106a can be controlled by controlling the mass of the first taxel 106a, or the stiffness of the beam 108a.

For example, a simplified determination of the mechanical resonance behaviour of the first taxel 106a can be provided by the mass-spring model. In a case where the mass is concentrated on the unattached end of the beam 108a and the stiffness is only related to the beam 108a, the mechanical resonance behaviour can be described by:

$$m \frac{{d}^{2} z}{d {t}^{2}} + ζ \frac{d z}{d t} + k z = F$$

Where z is the displacement of the unattached end of the taxel in response to the applied force F, k is the stiffness of the beam, ζ is the damping ratio and m is the mass at the unattached end of the beam.

The resonance frequency ωₙ of the taxel is then determined by:

ωₙ=\sqrt{k/m}

The beam stiffness k is a function of the beam geometry. For a beam with a rectangular cross section such as the beam 108a shown in FIG. 1, this is defined based on the beam length 1, width w and thickness t as:

$$k ∝ \frac{w {t}^{3}}{{l}^{3}}$$

The mechanical resonance frequency of the first taxel 106a can therefore be controlled by controlling dimensions of the first taxel 106a such as the width, length or thickness of the beam 108a.

The apparatus 100 additionally comprises a second taxel 106b which comprises a cantilever beam 108b, a magnetic portion 110b and a tactile protrusion 112b, arranged similarly to the first taxel 106a. In the example shown in FIG. 1, the first and second taxels 106a and 106b are arranged in a symmetric arrangement which enables the magnetic portions 110a and 110b of each taxel to be simultaneously aligned with one end of the solenoid 102 (although other arrangements that enable the magnetic portions to experience a magnetic force from one end of the solenoid could also be used). The unattached end of the first taxel 106a is spaced from the unattached end of the second taxel 106b to isolate the vibrating parts of the taxels 106a, 106b, to reduce sympathetic vibrations between the first and second taxels 106a and 106b. In some examples, there may be an air gap between the unattached ends of the first and second taxels 106a and 106b. The minimum size needed to avoid vibrations being transmitted between the taxels will depend on the Q-factor of the mechanical resonance, which will depend on the particular manufacturing technology used among other factors. For example, for 3D printed taxels an air gap of 1 mm may be used. In some examples, for 3D printed taxels, an air gap of at least 0.5 mm may be used.

The second taxel 106b is arranged to have a mechanical resonance at a different frequency from the mechanical resonance of the first taxel 106a. This enables the first and second taxels 106a, 106b to be controlled to vibrate selectively from a single solenoid 102, and also reduces sympathetic vibration between the first and second taxels 106a, 106b. The mechanical resonance of the second taxel 106b may be controlled to be different from the mechanical resonance of the first taxel 106a, for example by controlling the stiffness or mass of the second taxel 106b such as the thickness, width or length of the beam 108b or by adding a weight to either the first or second taxel 106a, 106b. The second electrical input signal 104b has a frequency that is chosen such that applying the second electrical input signal 104b to the solenoid 102 causes the second taxel 106b to vibrate at its mechanical resonance frequency.

Using a soft ferromagnet material for the magnetic portion means that when the magnetic field is exerting a force on the magnetic portion the force will always be in the same direction. Soft ferromagnetic materials are always attracted by a magnetic field while hard magnets can be repelled and attracted depending on the polarity of field and magnet.

The perpendicular mechanical force applied to a soft ferromagnetic material by a solenoid coil with N-turn winding that conducts electrical current I with cross-sectional area A at the ends of the coil, can be described as:

$$F = {μ}_{0} {μ}_{r}^{2} \frac{{N}^{2} A}{2 {l}^{2}} {I}^{2}$$

where μ₀, μᵣ and l are the magnetic permeability of free space, the relative permeability of a solenoid iron core and the solenoid length respectively.

The mechanical force in the taxel is therefore proportional to the square of the electrical current applied (for a hard ferromagnetic material the mechanical force applied will be a function of I rather than I²). Therefore supplying an electrical input signal at a particular frequency f₁ to the solenoid generates a proportional mechanical force with frequency 2f₁. Therefore, for a magnetic portion formed from a soft ferromagnetic material, the first electrical input signal 104a may be selected to have a frequency of half the frequency of the mechanical resonance frequency of the first taxel 106a and the second electrical input signal 104b may be selected to have a frequency of half the frequency of the mechanical resonance frequency of the second taxel 106b.

To vibrate both the first and second taxels 106a and 106b simultaneously, the first and second electrical input signals can be applied simultaneously to the solenoid 102. Supplying sinusoidal electrical currents of the form i(t)=I sin ωt at two different frequencies f₁ and f₂ (where W₁=2πf₁ and ω₂=2πf₂) results in the following mechanical force being applied to each taxel:

$$\begin{matrix}F = {μ}_{0} {μ}_{r}^{2} \frac{{N}^{2} A}{2 {l}^{2}} {( {i}_{1} ( t ) + {i}_{2} ( t ) )}^{2} \\ = {μ}_{0} {μ}_{r}^{2} \frac{{N}^{2} A}{2 {l}^{2}} {( {I}_{1} sin ( {ω}_{1} t ) + {I}_{2} sin ( {ω}_{2} t ) )}^{2} \\ = {μ}_{0} {μ}_{r}^{2} \frac{{N}^{2} A}{2 {l}^{2}} ( {I}_{1}^{2} {sin}^{2} ( {ω}_{1} t ) + 2 {I}_{1} {I}_{2} sin ( {ω}_{1} t ) sin ( {ω}_{2} t ) + {I}_{2}^{2} {sin}^{2} ( {ω}_{2} t ) )\end{matrix}$$

Therefore, when the first and second input signals 104a and 104b are input to the solenoid simultaneously, the solenoid converts the electrical power supplied at frequencies f₁ and f₂ from the first and second input signals 104a and 104b respectively to a mechanical force applied to each unattached end of the taxel at frequencies 2f₁, 2f₂ and f₁±f₂, thereby producing vibrations at both taxels simultaneously.

Applying both the first and second electrical input signals 104a and 104b to the solenoid 102 therefore causes both the first and second taxels 106a and 106b to vibrate. Thus, in the example shown in FIG. 1, the taxels can be both off (when neither the first or second input signals are applied to the solenoid 102), both vibrating, or either of the first and second taxels can be vibrating individually. Therefore the first and second taxels 106a and 106b can be controlled selectively which enables them to be integrated into a controllable taxel array e.g. to form a vibrotactile display. In some examples, the apparatus may comprise a controller (not shown) to selectively apply the first and second electrical input signals 104a and 104b to the solenoid 102, for example by controlling switches 105a and 105b.

When both electrical input signals 104a and 104b are applied to the solenoid individually, mechanical force at frequencies 2f₁, 2f₂ and f₁±f₂, is created. As the energy input to the system is being split between producing vibrations at four different frequencies, the amplitude of each of these vibrations may be lower than when only a single frequency is produced (by inputting a single electrical input frequency). Therefore, in some examples, the controller may be suitable to apply the first and second electrical input signals 104a and 104b at a higher amplitude when both the first and second electrical input signals are applied at the same time and at a relatively lower amplitude when the first or second electrical input signals are being applied individually. The controller may use a look-up table to store which power level to use based on which taxels are required to be active at any given time. In some examples, the power consumption of the solenoid is approximately 300 mW where this is the maximum coil power consumption which may be divided between two or more frequencies when exciting multiple taxels.

In some examples, the controller may be to apply the first and second electrical input signals 104a and 104b at different levels to provide different levels of vibration at the first and second taxels 106a and 106b. For example, to convey different information to a user.

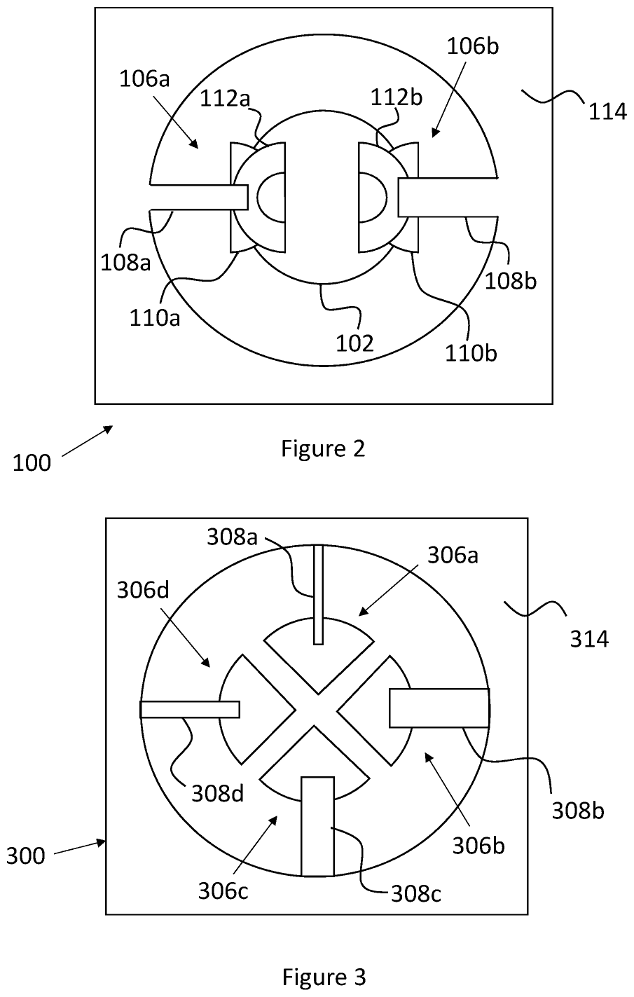

FIG. 2 shows a top-down view of the apparatus 100 of FIG. 1. In the example shown in FIG. 2, the first taxel cantilever beam 108a and the second taxel cantilever beam 108b are each connected to a common frame 114 to support the taxels 106a and 106b.

As shown in FIG. 2, the first taxel beam 108a has a smaller width than the width of the second taxel beam 108b, whilst other dimensions of the taxels are the same, so that the first taxel and the second taxel each have a different mechanical resonance frequency. In the example shown in FIG. 2, the first taxel 106a has a lower resonance frequency than the second taxel 106b. Keeping the size of the tactile pad the same and controlling the resonance by adjusting the beam dimensions means that the touch sensation provided by the taxels to a user remains similar.

In some examples, the taxels and the frame may be produced by 3D printing (additive manufacturing) techniques. In some examples the first and second taxels and the frame may be formed by mass manufacture techniques such as injection-moulding, blow-moulding, vacuum-forming, stamping or other suitable technique. In some examples the taxels may be formed from PLA (polylactic acid), ABS (acrylonitrile butadiene styrene), rubber, or resinous, or other resilient and flexible materials. In some examples the taxels may be formed from silicon, for example, using MEMS fabrication techniques. In some examples the taxels and the frame may be made from a combination of these materials and/or using a combination of these techniques.

In the example shown in FIG. 2 the first taxel 106a may be formed from PLA and may have an example mass at the unattached end of the beam 108a of between 0.1 g and 0.5 g and a beam stiffness of between 200 N/m and 500 N/m with example beam dimensions of 5 mm (length), 0.3 mm (thickness) and 1.5 mm (width) to provide a mechanical resonance frequency which is perceivable by human skin mechanoreceptors (the somatosystem), for example a mechanical resonance frequency of approximately 60 Hz. The second taxel 106b may be similar to the first taxel but with a beam width of 3 mm such that the second taxel 106b has a mechanical resonance frequency around 70 Hz The first electrical input frequency 104a may then be around 30 Hz and the second electrical input frequency 104b may be around 35 Hz. Where the magnetic portion of a taxel is a soft ferromagnetic material, the electrical input frequency for that taxel may be half the mechanical resonance frequency. Where the magnetic portion of the taxel is a hard ferromagnetic material, the electrical input frequency may be equal to the mechanical resonance frequency.

In some examples, three or more taxels may be selectively actuated using a single solenoid. For three taxels, the solenoid may have a further electrical input signal at a third frequency, wherein the third taxel has a mechanical resonance frequency such that applying the third electrical input signal to the solenoid causes the third taxel to vibrate at its mechanical resonance frequency.

FIG. 3 shows a taxel array 300 comprising four taxels 306a, 306b, 306c and 306d configured to be actuated by a single solenoid, as described above in relation to FIG. 1. In some examples, a taxel array may comprise two or more taxels, as described above in relation to FIGS. 1 and 2. The array 300 of FIG. 3 has a frame 314 similar to apparatus 100. Each of the four taxels 306a to 306d is attached to the frame by a cantilever support beam 108a, 108b, 108c and 108d respectively. In the example shown in FIG. 3, each of the taxels 306a to 306d has the same dimensions apart from the width of each of the cantilever support beams 108a to 108d, which is different for each taxel, such that each taxel has a different mechanical resonance frequency. In some examples, the mechanical resonance frequency of a particular taxel may be controlled by controlling a different dimension of the beam, or the mass at the unattached end of the taxel.

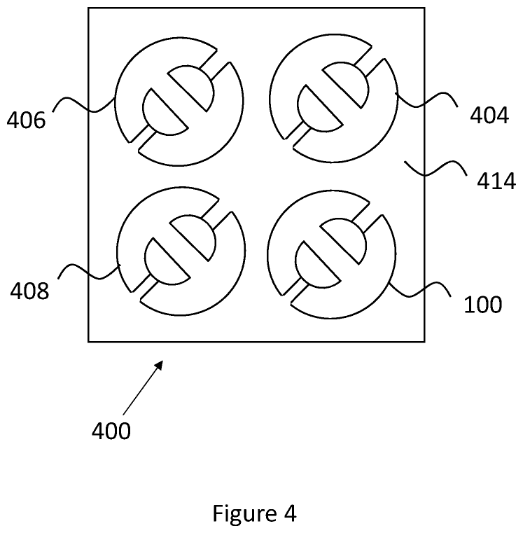

In some examples the apparatus 100 shown in FIGS. 1 and 2 may be arranged in an array with similar apparatuses to form a vibrotactile display 400. FIG. 4 shows an example of such an array which comprises apparatus 100 along with three further such apparatuses 404, 406 and 408 to provide an array of 8 taxels. The vibrotactile display 400 may also comprise a controller (not shown) to selectively actuate each taxel. In some examples the vibrotactile display 400 may comprise a connector such as a USB connector or a wireless connection, to connect with another device such as a computer or mobile phone, to receive graphical information from said device to be represented on the vibrotactile display.

In some examples, the strength of vibration of each of the taxels in the display may be selectively controllable by controlling the amplitude of the electrical signals input to the solenoids. For example, the vibration strength of each taxel may be used to represent a level of intensity, lightness, darkness, color or another property of a pixel of the graphical information to be represented on the vibrotactile display.

In the example shown in FIG. 4, each of the taxel apparatuses 100, 402, 404 and 408 share a single integral frame. This arrangement enables the array 400 to be efficiently manufactured, for example using 3D printing, or other mass-manufacture techniques such as injection moulding, vacuum forming, blow-moulding, stamping, or MEMS fabrication.

In the example of FIG. 4, the array is an array of 2×2 solenoids with each solenoid actuating two taxels, however the solenoids can be arranged in other arrays such as 1×n or other n×n arrays. In some examples other arrangements of taxel apparatuses each comprising a set of two or more taxels along with a single solenoid may be provided in other formations to provide taxel arrays of different dimensions.

Linear (1×n) or complex (n×n) arrays of taxels could also be utilised for haptic feedback purposes. Such feedback conveys information without the user having to actually look at the device, examples of which include driver information or controller information.

In some examples, tactile pixels as described above may be included in vehicles e.g. cars, to provide haptic feedback e.g. about the environment around the car. For example, cars may include tactile feedback devices in their controls, for example in the steering wheel, and in the seat bolster; such devices may indicate deviation of lane, or provide other indications such as turning direction in navigation.

In some examples, computer controllers or computer games consoles may include tactile pixels as described above in order to provide haptic feedback. For example, Computer games consoles may be supplied with one or more immersive controllers that can provide detailed and more high-definition haptic feedback and sensations on the user. This allows games to be more realistic, for example recoil from firing a weapon may feel different from falling over or crashing a vehicle in the game environment.

In some examples, surgical simulation equipment, i.e. instruments used for surgeons to practice with, for example in virtual reality environments, may include tactile pixels as described above to provide haptic feedback.

The word “comprising” does not exclude the presence of elements other than those listed in a claim, “a” or “an” does not exclude a plurality, and a single unit may fulfil the functions of several units recited in the claims.

The features of any dependent claim may be combined with the features of any of the independent claims or other dependent claims.

The example dimensions given in the example embodiments described herein may vary for different application or different manufacturing techniques.

1. An apparatus comprising:
a solenoid having a first electrical input signal at a first frequency and a second electrical input signal at a second frequency;
a first taxel, comprising a magnetic portion, located above an end of the solenoid, wherein the first taxel has a first mechanical resonance frequency such that applying the first electrical input signal to the solenoid causes the first taxel to vibrate;
a second taxel, comprising a magnetic portion located above the end of the solenoid, wherein the second taxel has a second mechanical resonance frequency, different from the first mechanical resonance frequency, such that applying the second electrical input signal to the solenoid causes the second taxel to vibrate.

2. The apparatus according to claim 1, wherein the first and second taxels each comprise a cantilever beam attached to a frame at an attached end, wherein the magnetic portion is located at an unattached end of the cantilever beam.

3. The apparatus according to claim 2, wherein the first taxel cantilever beam and the second taxel cantilever beam each have different dimensions.

4. The apparatus according to claim 3, wherein the first taxel cantilever beam and the second taxel cantilever beam each have different widths.

5. The apparatus according to claim 2, wherein the first taxel cantilever beam and the second taxel cantilever beam each have different masses located at their unattached ends.

6. The apparatus according to claim 2, wherein the first taxel cantilever beam comprises a different material from the second taxel cantilever beam.

7. The apparatus according to claim 2, wherein the first and second taxels are attached to a single frame.

8. The apparatus according to claim 7, wherein the first and second taxels and the frame are formed by 3D printing techniques.

9. The apparatus according to claim 1, wherein the magnetic portion comprises a soft ferromagnet.

10. The apparatus according to claim 1, wherein the first and second taxels each comprise a tactile protrusion arranged to be touchable by a user of the apparatus.

11. The apparatus according to claim 1, wherein the solenoid has a third electrical input signal at a third frequency;
the apparatus further comprising a third taxel, comprising a magnetic portion, located at an end of the solenoid, wherein the third taxel has a third mechanical resonance frequency, different from the first and second mechanical resonance frequencies, such that applying the third electrical input signal to the solenoid causes the third taxel to vibrate.

12. The apparatus according to claim 11, wherein the solenoid has a fourth electrical input signal at a fourth frequency;
the apparatus further comprising a fourth taxel, comprising a magnetic portion located above the end of the solenoid, wherein the fourth taxel has a fourth mechanical resonance frequency, different from the first, second and third mechanical resonance frequencies, such that applying the fourth electrical input signal to the solenoid causes the fourth taxel to vibrate.

13. The apparatus according to claim 1, further comprising a controller, wherein the controller is suitable to apply the first electrical input signal to the solenoid to vibrate the first taxel, and/or apply the second electrical input signal to the solenoid to vibrate the second taxel, and to apply the first and second frequencies to vibrate the first taxel and the second taxel, either simultaneously or individually.

14. The apparatus according to claim 13, wherein the controller is suitable to control an amplitude of the first and/or second electrical input signal in order to control a vibration amplitude of the first and/or second taxel.

15. The apparatus according to claim 14, wherein the controller is suitable to control the first and second electrical input signals to each have a relatively higher amplitude when both the first and second electrical input signals are applied to the solenoid simultaneously and is to control the first and second electrical input signals to each have a relatively lower amplitude when the first and second electrical input signals are applied to the solenoid individually.

16. A vibrotactile display comprising a plurality of solenoids arranged in an array, wherein each solenoid has a first electrical input signal at a first frequency and a second electrical input signal at a second frequency;
a first taxel, comprising a magnetic portion, located above an end of each solenoid, wherein the first taxel has a first mechanical resonance frequency such that applying the first electrical input signal to each solenoid causes the first taxel to vibrate;
a second taxel, comprising a magnetic portion located above the end of each solenoid, wherein the second taxel has a second mechanical resonance frequency, different from the first mechanical resonance frequency, such that applying the second electrical input signal to each solenoid causes the second taxel to vibrate.

17. An apparatus comprising a vibrotactile display according to claim 16, wherein the apparatus comprises one of a steering wheel, a vehicle seat bolster, a computer controller, a games console controller and a surgical simulation instrument.

18. A taxel array comprising:
a first taxel, comprising a magnetic portion, the first taxel having a first mechanical resonance frequency such that first taxel vibrates in response to the magnetic portion being energised by a first electromagnetic signal having a first frequency; and
a second taxel, comprising a magnetic portion, the second taxel having a second mechanical resonance frequency such that second taxel vibrates in response to the magnetic portion being energised by a second electromagnetic signal having a second frequency.

19. The taxel array according to claim 18, further comprising a third taxel, comprising a magnetic portion, the third taxel having a third mechanical resonance frequency such that the third taxel vibrates in response to the magnetic portion being energised by a third electromagnetic signal having a third frequency.

20. The taxel array according to claim 19, further comprising a fourth taxel, comprising a magnetic portion, the fourth taxel having a fourth mechanical resonance frequency such that the fourth taxel vibrates in response to the magnetic portion being energised by a fourth electromagnetic signal having a fourth frequency.
